(19) United States
(12) Patent Application Publication
(10) Pub. No.: US 2004/0159672 A1
(43) Pub. Date: Aug. 19, 2004

(54) Apparatus and methods for recirculating liquid dispensing systems

(75) Inventors: Jim Auber, Cumming, GA (US); Carl C. Cucuzza, Dacula, GA (US); Peter W. Estelle, Norcross, GA (US); David C. King JR., Duluth, GA (US); Scott Means, Lawrenceville, GA (US)

Correspondence Address: WOOD, HERRON & EVANS, LLP (NORDSON), 2700 CAREW TOWER, 441 VINE STREET, CINCINNATI, OH, 45202, US

(73) Assignee: Nordson Corporation

(21) Appl. No.: 10/761,736

(22) Filed: Jan. 21, 2004

Related U.S. Application Data
(60) Provisional application No. 60/444,300, filed on Jan. 31, 2003.

(51) Int. Cl. B67D 5/52; G01F 11/00

(52) U.S. Cl. 222/1; 222/135

(57) ABSTRACT

A method and apparatus for regulating backflow in a recirculation path coupling a three-way dispensing module with a liquid distribution manifold. The dispensing module and manifold are coupled together to provide a dispensing path for providing liquid from the manifold to the dispensing module for dispensing onto a substrate. A check valve positioned in the recirculation path ensures that liquid cannot flow from the recirculation path to the dispensing path as the dispensing valve of the dispensing module cycles from an open condition to a closed condition. This backflow prevention improves the accuracy of dispensed volumes of liquid.

### CROSS-REFERENCE TO RELATED APPLICATIONS

This application claims the benefit of U.S. Provisional Application Serial No. 60/444,300, filed on Jan. 31, 2003, the disclosures of these documents are hereby incorporated by reference herein.

### FIELD OF THE INVENTION

The present invention generally relates to liquid dispensing and, in particular, to liquid dispensers and dispenser nozzles for applying liquid to a substrate.

### BACKGROUND OF THE INVENTION

Liquids, including but not limited to hot melt adhesives, are dispensed and used in a variety of situations including the manufacture of diapers, sanitary napkins, surgical drapes as well as many others. Generally, liquid applicators will incorporate one or more individual dispensing modules for applying the intended deposition pattern and a manifold supplying liquid to the dispensing modules. In many dispensing applications, the flow of liquid is periodically interrupted to define a dispensed pattern. Accordingly, dispensing modules have a valve structure that includes a valve seat and a valve element capable of selective engagement with the valve seat. In an open position, the valve element is disengaged from the valve seat so that liquid is discharged from a discharge outlet downstream from the valve seat. In a closed position, the valve element is engaged with the valve seat for blocking the flow of liquid to the discharge outlet. Rapid cycling between the open and closed positions interrupts the flow and provides the intermittent flow according to application needs.

Three-way dispensing modules incorporate a valve structure that cycles between open and closed conditions. The dispensing module is maintained in the open condition for a dispensing time sufficient to dispense liquid from the discharge outlet to provide the intermittent features of the dispensed pattern. In the closed condition, the dispensing module is placed in a recirculating mode or condition in which the liquid is directed from an inlet of the module to a recirculation outlet.

Liquid applicators used with three-way dispensing modules generally include a manifold with distribution passageways and recirculation passageways. One or more pumps are used to pump the liquid through the distribution passageways to the dispensing modules. When each dispensing module is in the closed condition, each of the recirculation passageways receive liquid from the recirculation outlet of the corresponding dispensing module.

Certain liquid applicators are constructed from a plurality of manifold segments disposed in side-by-side relation. Each manifold segment is provided with a three-way dispensing module and a positive displacement pump. Liquid flows through a shared supply channel extending through the side-by-side manifold segments and is distributed to each pump. The pumps individually direct liquid to the corresponding dispensing module. Each of the manifold segments incorporates a recirculation passageway that routes the flow of liquid received from the recirculation outlet of the three-way dispensing module back to the supply channel when the dispensing module is in a closed condition. Because the number of manifold segments and dispensing modules define the effective dispensing length of the applicator, an end user can configure the liquid applicator according to their specific dispensing application.

A problem encountered in liquid applicators incorporating three-way dispensing modules is that, during intermittent dispensing, liquid flows unintentionally through the recirculation passageway as the valve element shifts from the open condition toward the closed condition. As a result, the applicator is not working as a positive displacement metering head in which the dispensed volumes of liquid are predictable and reproducible at high flow rates, independent of material viscosity. The unintentional flow through the recirculation passageway has the most significant impact on liquid application when the liquid flow is different and changing among the different three-way dispensing modules of the liquid applicator. Another problem encountered in such liquid applicators is slippage in gear pumps produced by large pressure differentials between their inlet and outlet sides.

Another problem which has arisen relates to the detection of either a failed or clogged nozzle and/or module. Current detection methods are less than optimal and may result in considerable product waste before a problem is detected and resolved. Current approaches to such detection schemes involve either detecting problems though end product inspection or machine malfunction due to the loss of adhesive on the product.

It would therefore be desirable to provide a liquid applicator with at least one three-way dispensing module, in which the dispensing module is not susceptible to backflow through a recirculation path to the dispensing module as the module cycles from the open condition to the closed condition. It would also be desirable to provide a quicker and more accurate indicator of either a failed or clogged nozzle condition to help prevent product and productivity loss as much as possible in such situations.

### SUMMARY OF THE INVENTION

The present invention overcomes the foregoing and other shortcomings and drawbacks of liquid applicators heretofore known. While the invention will be described in connection with certain embodiments, it will be understood that the invention is not limited to these embodiments. In particular, the principles of the invention are applicable to any type of liquid manifold or applicator system incorporating one or more recirculation paths and for the dispensing of any liquid, including but not limited to hot melt adhesive. On the contrary, the invention includes all alternatives, modifications and equivalents as may be included within the spirit and scope of the present invention.

Generally, one aspect of the invention relates to the introduction of a check valve into a recirculation path coupling the recirculation outlet of a three-way dispensing module in fluid communication with a liquid supply channel in a manifold. The check valve may be introduced into, for example, a portion of the recirculation path within the dispensing module, a portion of the recirculation path within the manifold, or a portion of the recirculation path in an adapter plate or other structure positioned between the dispensing module and the manifold. The invention also contemplates inserting the check valve into a recirculation path coupling the recirculation outlet of a three-way dispensing module with a recirculation channel or passage in the manifold that is distinct from the supply channel or passage and that has a separate liquid flow.

In accordance with the principles of the invention, a method is provided for applying liquid to a substrate. The method includes pumping liquid through a dispensing path in a manifold to a dispensing module, intermittently cycling a dispensing valve of the dispensing module between an open condition for applying liquid from the dispensing module to the substrate and a closed condition for returning liquid from the dispensing module to a recirculation path in the manifold, and preventing backflow of liquid from the recirculation path to the dispensing module when the dispensing valve is cycling from the open condition to the closed condition.

In accordance with the principles of the invention, a method of applying liquid to a substrate comprises coupling multiple modular manifold segments in a side-by-side relationship in which the manifold segments share a supply channel and pumping liquid from the supply channel through a dispensing path coupling each of the modular manifold segments with a corresponding one of multiple dispensing modules. The method further comprises intermittently cycling the dispensing module between an open condition for applying liquid from the dispensing module to the substrate and a closed condition for returning liquid from the dispensing module to the supply channel through a recirculation path, and preventing backflow of liquid from the recirculation path to the dispensing module when the dispensing valve is cycling from the open condition to the closed condition.

In accordance with the principles of the invention, one form of apparatus includes multiple modular manifolds arranged side-by-side for sharing a supply channel carrying liquid in which each of the modular manifolds includes a recirculation passageway coupled in fluid communication with the supply channel, a distribution passageway, and a pump operative for pumping liquid from the supply channel to the distribution passageway. The apparatus further includes multiple dispensing modules each having an inlet and a recirculation outlet coupled in fluid communication with the distribution passageway and the recirculation passageway, respectively, of one of the modular manifolds, and a plurality of check valves. In one embodiment, each check valve is positioned in the recirculation outlet of a corresponding one of the dispensing modules. In one alternative embodiment, each check valve is positioned in the recirculation passageway of a corresponding one of the manifold segments.

Another form of apparatus according to the invention includes a manifold having a supply channel carrying liquid, a recirculation passageway, a distribution passageway, and a pump operative for pumping liquid from the supply channel to the distribution passageway. The apparatus further includes a dispensing module having an inlet coupled in fluid communication with the distribution passageway and a recirculation outlet coupled in fluid communication with the recirculation passageway, and a check valve positioned in one of the recirculation outlet and the recirculation passageway.

In another form, the apparatus includes multiple modular manifolds arranged side-by-side for sharing a supply channel carrying liquid in which each of the modular manifolds including a recirculation passageway coupled in fluid communication with the supply channel, a distribution passageway, and a pump operative for pumping liquid from the supply channel to the distribution passageway. The apparatus further includes a plurality of dispensing modules each having an inlet and a recirculation outlet coupled in fluid communication with the distribution passageway and the recirculation passageway, respectively, of one of the modular manifolds. An adapter plate is provided that includes a plurality of recirculation passageways each coupling the recirculation passageway of one of the modular manifolds with the recirculation outlet of a corresponding one of the dispensing modules, and a plurality of check valves each positioned in one of the recirculation passageways of the adapter plate.

In another form, the apparatus includes a manifold having a supply channel carrying liquid, a recirculation passageway, a distribution passageway, and a pump operative for pumping liquid from the supply channel to the distribution passageway. The apparatus further includes a dispensing module having an inlet coupled in fluid communication with the distribution passageway and a recirculation outlet coupled in fluid communication with the recirculation passageway, an adapter plate having a recirculation passageway coupling the recirculation passageway with the recirculation outlet, and a check valve positioned in the recirculation passageway of the adapter plate.

Another form of the apparatus includes a manifold having a supply channel carrying liquid, a plurality of recirculation passageways, a plurality of distribution passageways, and at least one pump operative for pumping liquid from the supply channel to each of the distribution passageways. The apparatus further includes a plurality of dispensing modules each including an inlet coupled in fluid communication with one of the distribution passageways and a recirculation outlet coupled in fluid communication with one of the recirculation passageways. In addition, the apparatus includes an adapter plate having a plurality of recirculation passageways each coupling the recirculation passageway of the manifold with the recirculation outlet of a corresponding one of the dispensing modules, and a plurality of check valves each positioned in one of the recirculation passageways of the adapter plate.

In another aspect of the invention, which may be applicable in various liquid applicator systems including all of those described herein, the open or closed position of the check valve is sensed thereby indicating to a control whether or not there may be a clogged or failed nozzle condition. More specifically, a check valve position sensor is preferably located relative to the check valve to detect when the check valve has opened and allowed the liquid to enter the recirculation passage from the distribution passageway. In the case of a system having multiple check valves, multiple corresponding check valve position sensors may be utilized as well. The detection or sensor system may, for example, use various electromagnetic, inductive, capacitive, acoustic, optic, or other types of sensing technology. In the preferred embodiment, the recirculation valve element is separately movable from the dispensing valve element. When the dispensing valve element moves to the closed position, the recirculation valve element moves to the open condition thereby causing the liquid to enter the recirculation path as described above. Because of the fact that the recirculation valve element also moves independently of the dispensing valve element, if the nozzle becomes clogged and, therefore, pressure builds up against the recirculation valve element, the recirculation valve element will open to relieve the pressure and allow the liquid to enter the recirculation path in this case as well. This movement of the recirculation valve element is detected as described above, for example, and the control can then indicate the condition to an operator. This system can also detect failed operating solenoids, i.e., actuation error, used to open and close the dispensing valve element.

The above and other objects and advantages of the present invention shall be made apparent from the accompanying drawings and the description thereof.

### BRIEF DESCRIPTION OF THE DRAWINGS

The accompanying drawings, which are incorporated in and constitute a part of this specification, illustrate embodiments of the invention and, together with a general description of the invention given above, and the detailed description of the embodiments given below, serve to explain the principles of the invention.

FIG. 1 is a diagrammatic view of a modular adhesive applicator in accordance with the principles of the invention.

FIG. 2 is a cross-section of the modular adhesive applicator of FIG. 1 in which the dispensing module is in an open condition.

FIG. 3 is a cross-section of the modular adhesive applicator of FIG. 1 in which the dispensing module is in a closed condition.

FIG. 4 is a diagrammatic view of an alternative embodiment of a modular adhesive applicator in accordance with the principles of the invention.

FIG. 4A is an enlarged view of the check valve area shown in FIG. 4, but illustrating one form of detector or sensor for indicating the position of the check valve.

FIG. 5 is a diagrammatic view of an alternative embodiment of a modular adhesive applicator in accordance with the principles of the invention.

FIG. 6 is a schematic cross sectional view showing a valve module incorporating another detection system in accordance with the invention.

FIG. 6A is a cross sectional view of a portion of the schematic dispensing valve module shown in FIG. 6, but illustrating another type of detection system.

FIG. 6B is a fragmented cross sectional view similar to FIG. 6A but illustrating another alternative detection system.

### DETAILED DESCRIPTION OF THE PREFERRED EMBODIMENTS

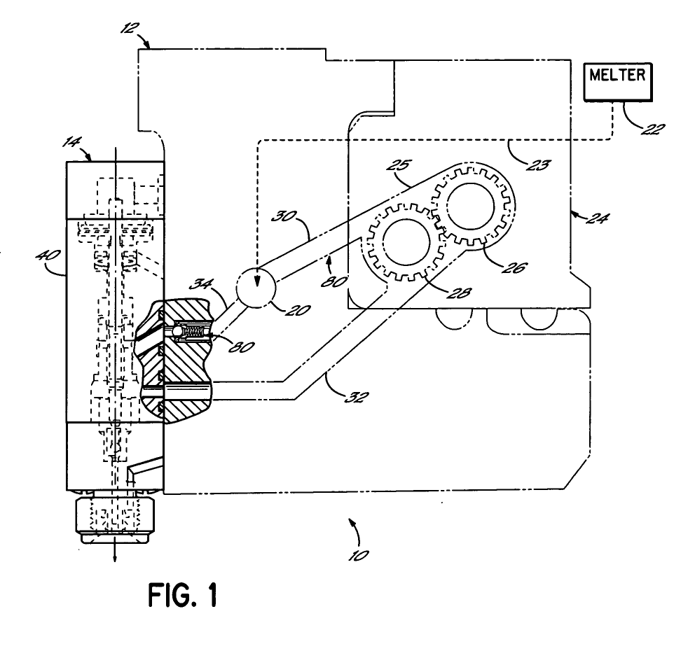

With reference to FIG. 1, a modular adhesive applicator 10 includes a plurality of manifold segments 12 and a corresponding plurality of three-way dispensing modules 14, of which one manifold segment 12 and one dispensing module 14 are shown. An exemplary dispensing module is disclosed in U.S. Pat. No. 6,089,413, assigned to the assignee of the present invention, and the disclosure of which is hereby fully incorporated by reference herein. An exemplary modular adhesive applicator and manifold segment are disclosed in U.S. Pat. No. 6,422,428, assigned to the assignee of the present invention, and the disclosure of which is hereby fully incorporated by reference herein.

With continued reference to FIG. 1, the manifold segments 12 are mounted in a side-by-side relationship for aligning a respective supply channel 20 extending through each segment 12. The aligned supply channels 20 receive a flow of liquid via a heated supply line 23 from a melter 22. Each of the manifold segments 12 is further provided with one of a corresponding plurality of gear pumps 24. A pumping chamber 25 in each of the gear pumps 24 houses a pair of drive gears 26, 28. An inlet side of the pumping chamber 25 is coupled with the supply channel 20 by a supply passageway 30 extending through the manifold segment 12. The drive gears 26, 28 provide metering precise amounts of liquid to a distribution passageway 32 extending through the manifold segment 12 to the corresponding one of the dispensing modules 14. The metered amounts of liquid are contingent upon how fast the drive gears 26, 28 are rotated. A recirculation passageway 34 extends through the manifold segment 12 from the dispensing module 14 to the supply channel 20. The recirculation passageway 34 receives liquid from dispensing module 14 when the module 14 is in the closed condition. The invention contemplates that the manifold segments 12 may incorporate aligned recirculation channels (not shown) that are distinct from the aligned supply channels 20 and that receive liquid from the recirculation passageways 34 for return to the melter 22.

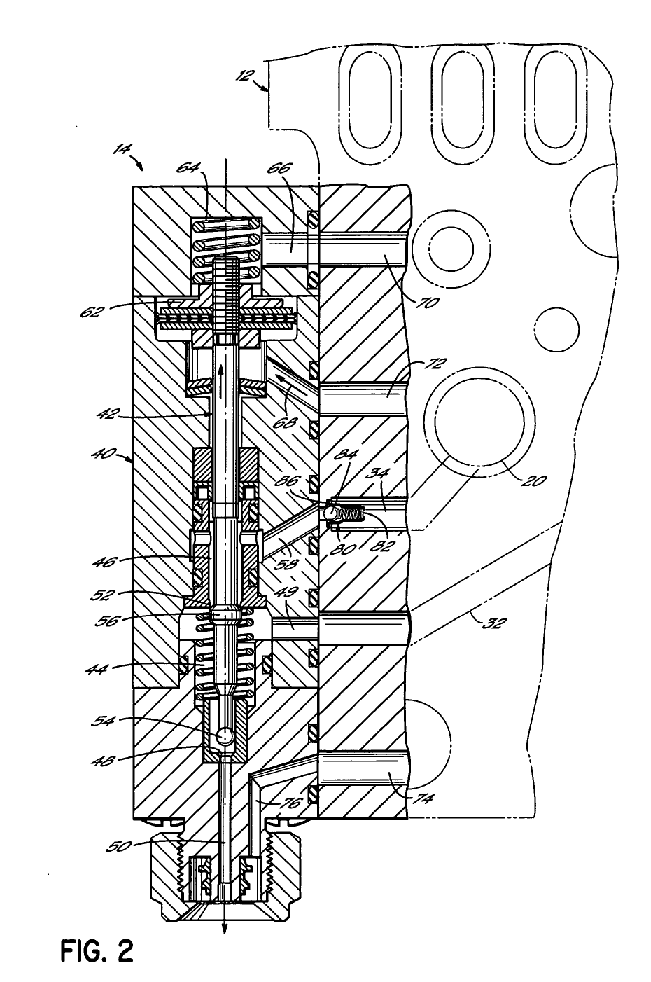

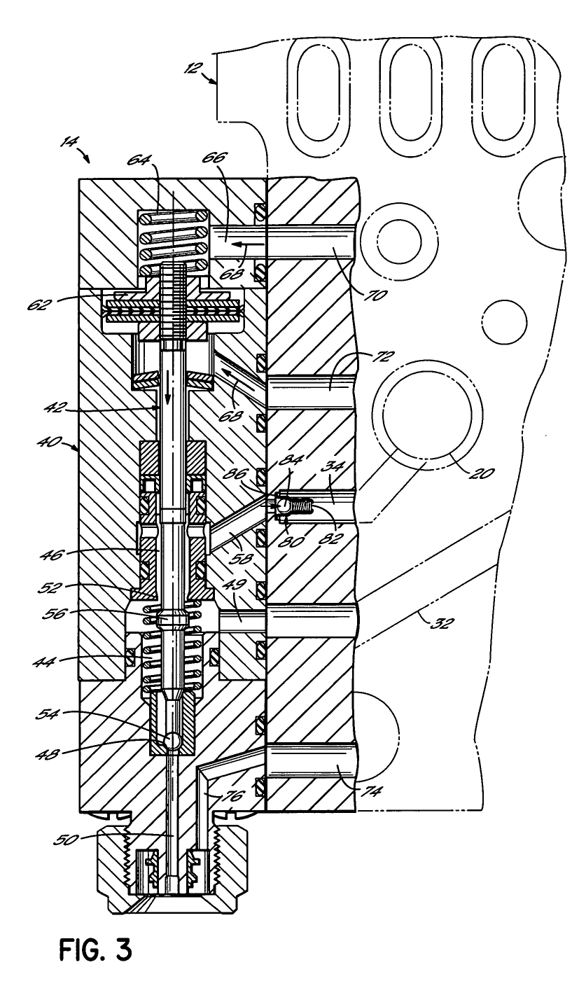

With reference to FIGS. 2 and 3, three-way dispensing module 14 generally includes a module body 40, a valve stem 42 mounted for movement within the module body 40, a supply chamber 44 formed in the module body 40, and a recirculation chamber 46 also formed in the module body 40. A valve seat 48 is disposed between an inlet 49 and a discharge passageway 50 at the juncture of the supply chamber 44 and the discharge passageway 50. A spherical valve element 54 is positioned on valve stem 42 for engaging valve seat 48 when the dispensing module 14 is in a closed condition (FIG. 3). Valve element 54 is spaced from valve seat 48 when the dispensing module 14 is in an open condition (FIG. 2). In the open condition, liquid can flow from inlet 49 through supply chamber 44 and an annular gap between valve element 54 and valve seat 48 into the discharge passageway 50 for dispensing onto a substrate.

Disposed generally between supply chamber 44 and recirculation chamber 46 is a valve seat 52 selectively engaged by a valve element 56 on valve stem 42. When the dispensing module 14 is in the open condition (FIG. 2) with valve element 54 disengaged from valve seat 48, valve element 56 is engaged with valve seat 52 for preventing flow between supply chamber 44 and recirculation chamber 46. When the dispensing module 14 is in the closed condition (FIG. 3) with valve element 54 engaged in a contacting relationship with valve seat 48, valve element 56 is disengaged from valve seat 52. As a result, liquid flowing through inlet 49 into supply chamber 44 passes through the annular gap between valve seat 52 and valve element 56 into the recirculation chamber 46. Liquid entering the recirculation chamber 46 is exhausted through a recirculation outlet 58 and received by recirculation passageway 34 of the manifold segment 12 for return to the supply channel 20.

With continued reference to FIGS. 2 and 3, the valve stem 42 is moved to provide the open and closed conditions by the selective application of air pressure to a piston assembly 62. A coil spring 64 applies a force to the valve stem 42 that urges the valve element 54 into a contacting relationship with valve seat 48. Module body 40 has a pair of air inlets 66, 68 that provide pressurized air to opposite sides of the piston assembly 62 sufficient to supply the open and closed conditions. The air inlets 66, 68 are coupled in fluid communication with air passageways 70, 72, respectively, in manifold segment 12 that supply air pressure in a manner suitable for moving the piston assembly 62. An air inlet 74 in manifold segment 12 provides process air to a process air passageway 76, which exhausts process air proximate to the discharge outlet of discharge passageway 50 for manipulating a property of the dispensed liquid.

When the dispensing module 14 is in the open condition, a dispensing path is defined from the outlet side of the pump 24 by distribution passageway 32, inlet 49, supply chamber 44, and discharge passageway 50. When the dispensing module 14 is in the closed condition, a recirculation path to supply channel 20 is defined by distribution passageway 32, inlet 49, supply chamber 44, recirculation chamber 46, recirculation outlet 58, and recirculation passageway 34.

According to the principles of the invention and with reference to FIGS. 1-3, a check valve 80 is inserted into the recirculation passageway 34 of the manifold segment 12. Check valve 80 includes a spring 82 that biases a valve body or ball 84 against a seat 86. The spring force of spring 82 is selected to provide a characteristic cracking pressure for which the ball 84 is deflected by applied pressure into a non-contacting relationship with seat 86. In addition, liquid in the supply channel 20, and hence in the recirculation passageway 34, is maintained at a greater fluid pressure than liquid in the recirculation outlet 58 (and, hence, supply and recirculation chambers 44, 46) of the dispensing module 14 up and until approximately the moment that valve element 54 achieves a contacting relationship with valve seat 48 to place the dispensing module 14 in the closed condition.

In other words, the fluid pressure in the supply chamber 44 is maintained greater than the sum of the fluid pressure in the recirculation passageway 34 (and, hence, in supply channel 20) and the cracking pressure during the characteristic closing time required for the dispensing module 14 to cycle from the open condition to the closed condition. As the valve element 54 approaches and contacts the valve seat 48, the fluid pressure builds in the supply and recirculation chambers 44, 46 until the fluid pressure of liquid in the recirculation outlet 58 exceeds the sum of the fluid pressure of liquid in the recirculation passageway 34 and the cracking pressure. Check valve 80 opens only after valve element 54 contacts the valve seat 48. In effect, liquid flow is prevented from the recirculation passageway 34 into the recirculation outlet 58 during the characteristic closing time.

With reference to FIGS. 1-3, the fluid pressure of liquid in the supply channel 20 (and, hence, in recirculation passageway 34) is regulated by controlling the pressure of the liquid being supplied to the supply chamber 20 by the melter 22. The fluid pressure in the supply chamber 44 when the dispensing module 14 is in the open condition is determined by the fluid flow restrictions of discharge passageway 50. When valve element 56 is disengaged from valve seat 52, the fluid pressure in the supply and recirculation chambers 44, 46 equilibrates and begins to rise as valve element 54 approaches valve seat 48. Therefore, the fluid pressure of liquid being supplied to the supply channel 20 and recirculation passageway 34 by the melter 22 must exceed the fluid pressure present in the recirculation chamber 46 and recirculation outlet 58, less the cracking pressure, until valve element 54 contacts valve seat 48.

Check valve 80 permits forward flow of fluid from recirculation outlet 58 to recirculation passageway 34 when the fluid pressure in recirculation outlet 58 exceeds the sum of the fluid pressure in the recirculation passageway 34 and the cracking pressure of check valve 80. In this situation, spring 82 is compressed and ball 84 is displaced from the seat 86 to create an annular flow path therebetween for recirculation of liquid entering module body 40 through inlet 49. Therefore, when the dispensing module 14 is in a closed condition, liquid flows through the recirculation path.

Check valve 80 may be any suitable valve that closes by fluid pressure to prevent return flow. Exemplary check valves 80 suitable for use in the invention are commercially available from The Lee Company (Westbrook, Conn.). A particularly suitable check valve 80 for use in the invention is the forward-flow, 6 psid cracking pressure 558 Series Chek Valve also commercially available from The Lee Company (Westbrook, Conn.).

In use and with reference to FIGS. 1-3, liquid is pumped from melter 22 into the aligned supply channels 20 of the coupled manifold segments 12. Liquid is withdrawn from the supply channel 20 through supply passageway 30 by the gear pump 24 associated with the manifold segment 12. Metered volumes of liquid are provided by gear pump 24 to the three-way dispensing module 14 associated with the manifold segment 12.

When the dispensing module 14 is in the open condition, the check valve 80 remains closed (ball 84 seated against seat 86) because the fluid pressure of liquid in the recirculation passageway 34 exceeds the fluid pressure of liquid in the recirculation outlet 58. In addition, valve element 56 is engaged with valve seat 52 so that liquid flows through the dispensing path. As a result, liquid cannot backflow from the recirculation passageway 34 into the recirculation chamber 46 or supply chamber 44 and, instead, is forced to flow through recirculation passageway 34 back to the supply channel 20. This aids in ensuring that an accurate volume of liquid is dispensed onto the substrate as only liquid received in supply chamber 44 from inlet 49 is routed to discharge passageway 50 for dispensing onto the substrate.

When the dispensing module 14 cycles from the open condition to the closed condition, the ball 84 of check valve 80 remains engaged in a contacting relationship against seat 86. As a result, liquid cannot flow from the recirculation passageway 34 of manifold 12 through recirculation outlet 58 to the recirculation chamber 46, and ultimately to the supply chamber 44. This further ensures that an accurate volume of liquid is dispensed onto the substrate as only liquid received in supply chamber 44 from inlet 49 is routed to discharge passageway 50. As a result, modular adhesive applicator 10 is operating as a positive displacement metering head in which the dispensed volumes of liquid are predictable and reproducible at high flow rates, independent of material viscosity.

When the dispensing module 14 is in the closed condition, the fluid pressure of liquid in the supply and recirculation chambers 44, 46 and recirculation outlet 58 exceeds the cracking pressure of the check valve 80. The ball 84 is displaced by the fluid pressure from seat 86 to open check valve 80 so that liquid flows from inlet 49 through the supply and recirculation chambers 44, 46, the recirculation outlet 58, and the recirculation passageway 34 back to the supply channel 20. When the dispensing module 14 cycles from the closed condition back to the open condition, the check valve 80 remains seated. As a result, liquid cannot flow from the recirculation passageway 34 to the recirculation outlet 58 during this transition in the state of the dispensing module 14.

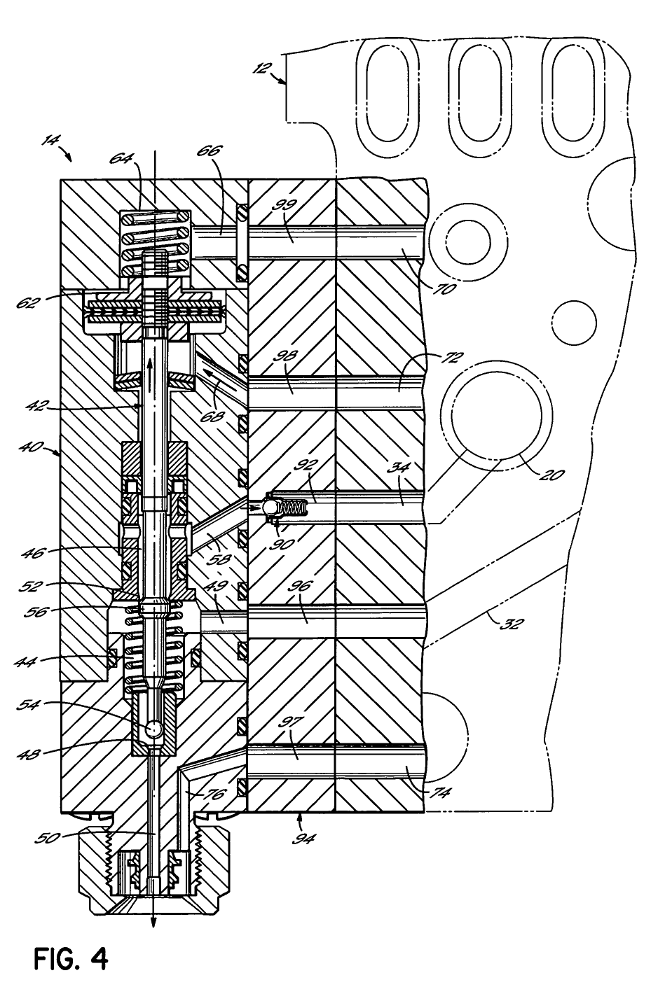

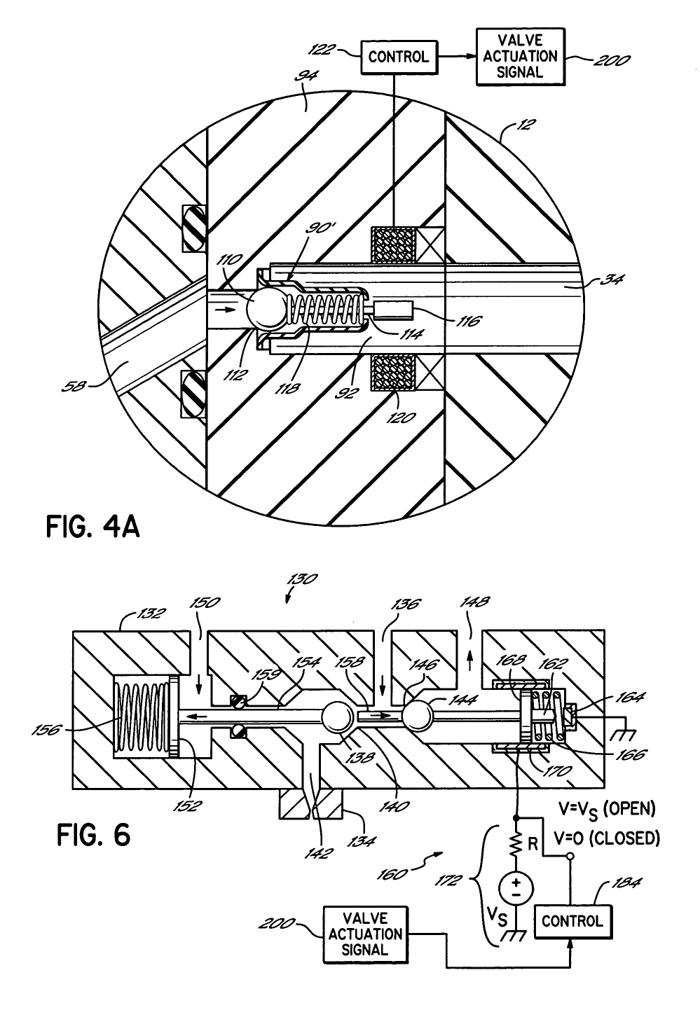

With reference to FIG. 4 in which like reference numerals refer to like features in FIGS. 1-3 and in accordance with an alterative embodiment of the invention, a check valve 90 may be positioned within a recirculation passageway 92 provided in an adapter plate 94 interposed between the manifold segment 12 and the dispensing module 14. The recirculation passageway 92 provides a fluid path coupling recirculation passageway 34 with recirculation outlet 58. The check valve 90, is identical in structure and operation to check valve 80 described above with regard to FIGS. 1-3. An inlet passageway 96 in the adapter plate 94 couples inlet 49 with distribution passageway 32. Additional passageways 97-99 are provided in the adapter plate 94 for the various different air flows.

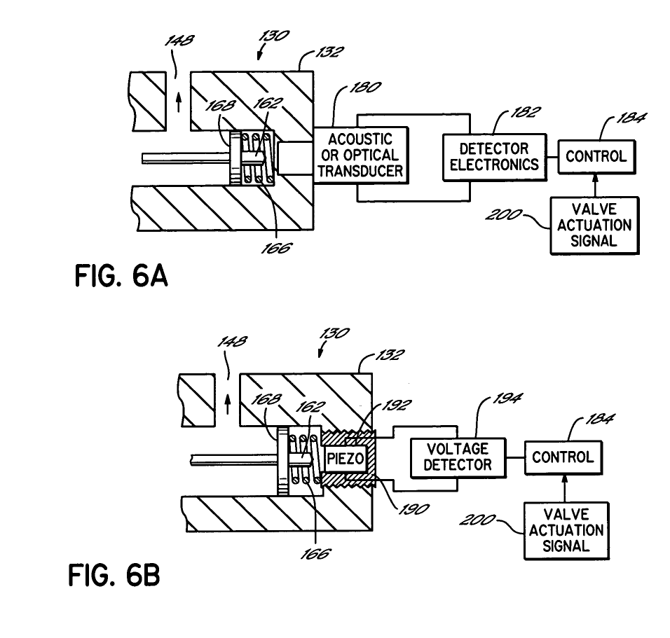

FIG. 4A illustrates an alternative embodiment in which like reference numerals refer to like features in FIG. 4 and like reference numerals having prime marks (′) refer to corresponding elements in FIG. 4 which have been modified in the embodiment shown in FIG. 4A. In this alternative embodiment, check valve 90′ includes a valve element 110 in the form of a ball engaging a valve seat 112 to control flow of liquid between passageway 34 and recirculation outlet 58 as previously described. A stem portion 114 coupled with ball or valve element 110 preferably carries an element 116 formed from a magnetic material. Pressure within outlet 58, when sufficiently built up, will cause valve element 110 to move to the right, as viewed in FIG. 4A, against the force of coil spring 118 thereby also moving element 116. This movement, or change in position, disturbs a magnetic field in an electromagnetic coil 120 positioned about element 116. This induces a current in the coil 120 which is detected by a suitable control 122. If the control also detects that the dispensing valve element 54 is, or should be, in the open condition, this will indicate that the nozzle is clogged or otherwise in failure and the operator can be suitably instructed in that regard. The detection system can also indicate the failure of the actuating portion of the dispensing module 14. In that regard, and referring to FIG. 4, if valve stem 42 fails to open when actuating air is introduced through air passageway 72, or the system control has at least been placed into a valve opening mode, and the check valve 90′ is nonetheless detected to be open, then this will indicate a failure of the valve actuation. An operator may also be instructed in that regard so that suitable corrective action may be taken. It will be appreciated that other sensing technology may be used in place of electromagnetic coil 120, such as other inductive or capacitive proximity sensors. Additional examples of suitable sensing systems are described in connection with FIGS. 6, 6A and 6B.

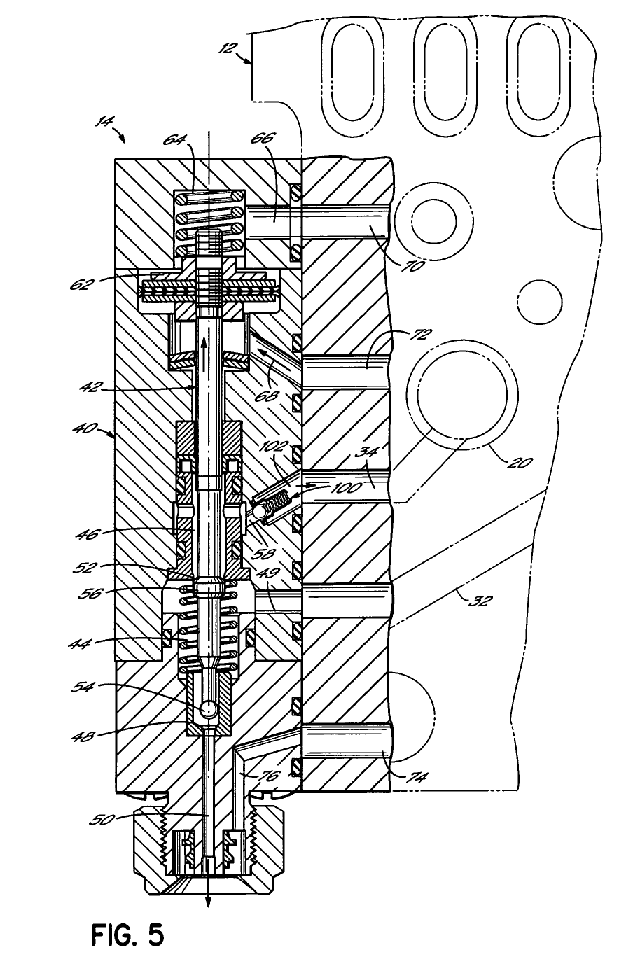

With reference to FIG. 5 in which like reference numerals refer to like features in FIGS. 1-3 and in accordance with an alterative embodiment of the invention, a check valve 100 may be positioned within a portion 102 of the recirculation outlet 58. Check valve 100 is identical in structure and operation to check valves 80 and 90 described above with regard to FIGS. 1-4. The diameter of portion 102 may be enlarged relative to the remainder of recirculation outlet 58, as depicted in FIG. 5, or may have a diameter substantially equal to the remainder of recirculation outlet 58.

The invention contemplates that the manifold segments 12 may be replaced by a conventional manifold having multiple different distribution passageways and multiple different recirculation passageways. Each of the distribution passageways receives liquid pumped from one or more gear pumps and routes the liquid to the inlet of one of the three-way dispensing modules. Each of the recirculation passageways in the manifold constitutes a portion of a recirculation path in which a check valve is located according to the principles of the invention, as described herein.

FIGS. 6, 6A and 6B each diagrammatically illustrate alternative valve modules constructed in accordance with the inventive aspects and, particularly, having different types of sensing systems for detecting the movement or change in position of the recirculation valve element for purposes generally similar to those described above in connection with FIG. 4A.

FIG. 6 illustrates a valve module 130 comprised of a module body 132 and a nozzle 134 for dispensing liquid onto any desired substrate. The liquid enters module body 132 through a supply channel or passage 136. When the dispensing valve element 138 is in the open condition shown, spaced away from valve seat 140, the liquid will flow through discharge passageway 142 and out of nozzle 134. During normal operation, a recirculation valve element 144 will be in a closed condition as shown against valve seat 146 due to the force of a spring 106. The liquid will enter a recirculation passageway 148 when, for example, pressurized air is no longer introduced into air passageway 150 and, therefore, diaphragm member 152 moves valve stem 154 to the closed position because of the force generated by coil spring 156. This pushes valve element 138 against valve seat 140 and also pushes valve stem 158 to the right, as viewed in FIG. 6, thereby moving recirculation valve element 144 away from valve seat 146. A dynamic seal 159 prevents the exchange of air and liquid between the actuation and dispensing portions of valve module 130.

A sensor 160 is incorporated into valve module 130 for detecting the movement or change in position of recirculation valve element 144 to the open condition. More specifically, sensor 160 comprises a system including an electrically conductive element 162 which is normally held away from an electrical contact element 164 by coil spring 166. Electrical contact element 164 is electrically insulated from module body 132 and connected to ground. Another electrically conductive element 168 is connected to element 162 and slides in contact with an electrically conductive element 170 which is electrically isolated from module body 132. A voltage detector 172 is electrically connected to element 170 and detects the change in voltage between 0 and Vₛ respectively indicating closed and open circuit conditions when elements 162, 164 are in contact or out of contact. The circuit condition is communicated to a control 184 thereby indicating whether recirculation valve element 144 is closed or open. If the control 184 determines that dispensing valve element 138 is or should be in the open condition and yet is instructed by sensor 160 that contact is being made between elements 162, 164, the control prompts the operator accordingly, such as by indicating a failure mode and the need to take corrective action with respect to module 130. In this case, for example, nozzle 134 could be clogged or the actuating structure or components associated with dispensing valve 138 may have failed.

FIG. 6A illustrates an alterative detection system coupled with valve module 130. Like numerals in FIG. 6A refer to like elements of FIG. 6. FIG. 6A illustrates the alternative use of an acoustic or optical transducer 180 which can detect a change in position or movement of element 162 which, as described in connection with FIG. 6, indicates an open condition of recirculation valve element 144. Element 162 may, for example, move into a position which impacts another surface thereby creating sound waves detected by an acoustic transducer or into a position which changes the reflectance of light detected by an optical transducer. Such conditions detected by an acoustic or optical transducer 180 may be processed through suitable conventional detector electronics 182 and an appropriate signal or indication communicated to control 184. In such cases, control 184 will preferably prompt the operator and indicate that valve module 130 is in a failure mode as described above.

FIG. 6B illustrates another alternative embodiment in which like reference numerals refer to like elements of structure in FIGS. 6 and 6A. In this embodiment, an alternative detector is utilized in the form of an insert 190 carrying a piezoelectric element 192. When piezoelectric element 192 is impacted by element 162 during opening of recirculation valve element 144 (FIG. 6), the voltage produced by the impact is detected by a voltage detector 194 and this is communicated to control 184 whereupon the same prompts, instructions, corrective actions or other suitable activity may take place at the earliest possible time. Optionally, piezoelectric element 192 may be isolated from the fluid cavity within module body 132 similar to the transducers represented in FIG. 6A.

As further shown in FIGS. 4A, 6, 6A and 6B, controls 122, 184 monitor the valve actuation signal 200, i.e., as to whether the valve element 54 or 154 is or should be in the open position. As discussed above, controls 122, 184 receive this information to then enable a determination as to whether the module is in a failure mode.

While the present invention has been illustrated by a description of various embodiments and while these embodiments have been described in considerable detail, it is not the intention of the applicants to restrict or in any way limit the scope of the appended claims to such detail. Additional advantages and modifications will readily appear to those skilled in the art. The invention in its broader aspects is therefore not limited to the specific details, representative apparatus and methods, and illustrative examples shown and described. Accordingly, departures may be made from such details without departing from the spirit or scope of applicants' general inventive concept.

We claim:

1. A method of applying liquid to a substrate, comprising:
pumping liquid through a dispensing path in a manifold to a dispensing module;
intermittently cycling a dispensing valve of the dispensing module between an open condition for applying liquid from the dispensing module to the substrate and a closed condition for returning liquid from the dispensing module to a recirculation path in the manifold; and
preventing backflow of liquid from the recirculation path to the dispensing module when the dispensing valve is cycling from the open condition to the closed condition.

2. The method of claim 1, wherein the liquid is a hot melt adhesive.

3. The method of claim 1, further comprising:
maintaining a pressure of liquid in the recirculation path greater than a pressure of liquid in the dispensing path as the dispensing valve is cycled from the open condition to the closed condition.

4. The method of claim 1, further comprising:
maintaining a pressure of liquid in the recirculation path greater than a pressure of liquid in the dispensing path when the dispensing valve is in the open condition.

5. The method of claim 1, further comprising:
maintaining a pressure of liquid in the recirculation path less than a pressure of liquid in the dispensing path when the dispensing valve is in the closed condition.

6. The method of claim 1, wherein preventing backflow of liquid further comprises positioning a check valve in the recirculation path.

7. The method of claim 6, further comprising:
sensing whether the check valve is open or closed.

8. The method of claim 6, further comprising:
maintaining a pressure of liquid in the recirculation path greater than a pressure of liquid in the dispensing path as the dispensing valve is cycled from the open condition to the closed condition.

9. The method of claim 1, wherein liquid is pumped from a supply channel to the dispensing path and the recirculation path returns liquid to the supply channel.

10. The method of claim 1, wherein liquid is pumped from a supply channel to the dispensing path and the recirculation path returns liquid to a recirculation channel isolated from the supply channel.

11. A method of applying liquid to a substrate, comprising:
coupling a plurality of manifold segments in a side-by-side relationship in which the manifold segments share a supply channel carrying liquid;
pumping liquid from the supply channel through a dispensing path coupling each of the manifold segments with a corresponding one of a plurality of dispensing modules;
intermittently cycling at least one of the dispensing modules between an open condition for applying liquid from the dispensing module to the substrate and a closed condition for returning liquid from the dispensing module to the supply channel through a recirculation path; and
preventing backflow of liquid from the recirculation path to the dispensing module when the dispensing valve is cycling from the open condition to the closed condition.

12. The method of claim 11, further comprising:
maintaining a pressure of liquid in the recirculation path greater than a pressure of liquid in the dispensing path as the dispensing valve is cycled from the open condition to the closed condition.

13. The method of claim 11, wherein preventing backflow of liquid further comprises positioning a check valve in the recirculation path.

14. The method of claim 13, further comprising:
sensing whether the check valve is open or closed.

15. The method of claim 13, further comprising:
maintaining a pressure of liquid in the recirculation path greater than a pressure of liquid in the dispensing path.

16. The method of claim 10, wherein the liquid is a hot melt adhesive.

17. An apparatus for applying liquid to a substrate, comprising:
a plurality of modular manifolds arranged side-by-side for sharing a supply channel carrying liquid, each of said modular manifolds including a recirculation passageway coupled in fluid communication with said supply channel, a distribution passageway, and a pump operative for pumping liquid from said supply channel to said distribution passageway;
a plurality of dispensing modules each including an inlet and a recirculation outlet coupled in fluid communication with said distribution passageway and said recirculation passageway, respectively, of one of said modular manifolds; and
a plurality of check valves, one of each of said check valves positioned in said recirculation outlet of a corresponding one of said plurality of dispensing modules.

18. An apparatus for applying liquid to a substrate, comprising:
a plurality of modular manifolds arranged side-by-side for sharing a supply channel carrying liquid, each of said modular manifolds including a recirculation passageway coupled in fluid communication with said supply channel, a distribution passageway, and a pump operative for pumping liquid from said supply channel to said distribution passageway;
a plurality of dispensing modules each including an inlet and a recirculation outlet coupled in fluid communication with said distribution passageway and said recirculation passageway, respectively, of one of said modular manifolds; and
a plurality of check valves, one of each of said check valves positioned in said recirculation passageway of a corresponding one of said plurality of manifold segments.

19. An apparatus for applying liquid to a substrate, comprising:
a manifold including a supply channel carrying liquid, a recirculation passageway, a distribution passageway, and a pump operative for pumping liquid from said supply channel to said distribution passageway;
a dispensing module including an inlet coupled in fluid communication with said distribution passageway and a recirculation outlet coupled in fluid communication with said recirculation passageway; and
a check valve positioned in at least one of said recirculation outlet and said recirculation passageway.

20. The apparatus of claim 19, wherein said recirculation passageway is coupled in fluid communication with said supply channel.

21. The apparatus of claim 19, further comprising:
a check valve position sensor located relative to said check valve to detect when said check valve has opened and allowed the liquid to enter said recirculation passageway from said distribution passageway.

22. An apparatus for applying liquid to a substrate, comprising:
a manifold including a supply channel carrying liquid, a plurality of recirculation passageways, a plurality of distribution passageways, and at least one pump operative for pumping liquid from said supply channel to each of said distribution passageways;
a plurality of dispensing modules each including an inlet coupled in fluid communication with one of said distribution passageways and a recirculation outlet coupled in fluid communication with one of said recirculation passageways; and
a plurality of check valves, one of each of said check valves positioned in a corresponding one of said recirculation passageways of said manifold.

23. The apparatus of claim 22, wherein each of said plurality of recirculation passageways is coupled in fluid communication with said supply channel.

24. The apparatus of claim 22, further comprising:
a plurality of check valve sensors, each sensor located relative to a corresponding one of said check valves to detect when said corresponding one of said check valves has opened and allowed the liquid to enter said corresponding one of said recirculation passageways and a corresponding one of said distribution passageways.

25. An apparatus for applying liquid to a substrate, comprising:
a manifold including a supply channel carrying liquid, a plurality of recirculation passageways, a plurality of distribution passageways, and at least one pump operative for pumping liquid from said supply channel to each of said distribution passageways;
a plurality of dispensing modules each including an inlet coupled in fluid communication with one of said distribution passageways and a recirculation outlet coupled in fluid communication with one of said recirculation passageways; and
a plurality of check valves, one of each of said check valves positioned in said recirculation outlet of a corresponding one of said dispensing modules.

26. The apparatus of claim 25, wherein each of said plurality of recirculation passageways is coupled in fluid communication with said supply channel.

27. The apparatus of claim 25, further comprising:
a plurality of check valve sensors, each sensor located relative to a corresponding one of said check valves to detect when said corresponding one of said check valves has opened and allowed the liquid to enter said corresponding one of said recirculation passageways and a corresponding one of said distribution passageways.

28. An apparatus for applying liquid to a substrate, comprising:
a plurality of modular manifolds arranged side-by-side for sharing a supply channel carrying liquid, each of said modular manifolds including a recirculation passageway coupled in fluid communication with said supply channel, a distribution passageway, and a pump operative for pumping liquid from said supply channel to said distribution passageway;
a plurality of dispensing modules each including an inlet and a recirculation outlet coupled in fluid communication with said distribution passageway and said recirculation passageway, respectively, of one of said modular manifolds;
an adapter plate having a plurality of recirculation passageways each coupling said recirculation passageway of one of said plurality of modular manifolds with said recirculation outlet of a corresponding one of said dispensing modules; and
a plurality of check valves, one of each of said check valves positioned in a corresponding one of said recirculation passageways of said adapter plate.

29. An apparatus for applying liquid to a substrate, comprising:
a manifold including a supply channel carrying liquid, a recirculation passageway, a distribution passageway, and a pump operative for pumping liquid from said supply channel to said distribution passageway;
a dispensing module an inlet coupled in fluid communication with said distribution passageway and a recirculation outlet coupled in fluid communication with said recirculation passageway;
an adapter plate having a recirculation passageway coupling said recirculation passageway with said recirculation outlet; and
a check valve positioned in said recirculation passageway of said adapter plate.

30. The apparatus of claim 29, wherein each of said plurality of recirculation passageways is coupled in fluid communication with said supply channel.

31. An apparatus for applying liquid to a substrate, comprising:
a manifold including a supply channel carrying liquid, a plurality of recirculation passageways, a plurality of distribution passageways, and at least one pump operative for pumping liquid from said supply channel to each of said distribution passageways;
a plurality of dispensing modules each including an inlet coupled in fluid communication with one of said distribution passageways and a recirculation outlet coupled in fluid communication with one of said recirculation passageways; and
an adapter plate having a plurality of recirculation passageways each coupling said recirculation passageway of one of said manifold with said recirculation outlet of a corresponding one of said dispensing modules; and
a plurality of check valves, one of each of said check valves positioned in a corresponding one of said recirculation passageways of said adapter plate.

32. The apparatus of claim 31, wherein each of said plurality of recirculation passageways is coupled in fluid communication with said supply channel.

33. A method of applying liquid to a substrate, comprising:
pumping liquid through a dispensing path extending through a manifold and a dispensing module;
cycling the dispensing module to an open condition thereby dispensing liquid from the dispensing module to the substrate;
cycling the dispensing module to a recirculating condition preventing liquid from dispensing onto the substrate;
returning liquid from the dispensing module to a recirculation path in the manifold while the dispensing module is in the closed condition; and
sending a signal to a control coupled with the dispensing module indicating that the dispensing module is in the recirculating condition.

34. The method of claim 33, wherein the dispensing module further comprises a movable valve element configured to selectively place the dispensing module in the recirculating condition and further comprising:
magnetically sensing a change in the position of the movable valve element, and
sending the signal after magnetically sensing the change in the position of the movable valve element.

35. The method of claim 33, wherein the dispensing module further comprises a movable valve element configured to selectively place the dispensing module in the recirculating condition and further comprising:
electrically sensing a change in the position of the movable valve element, and
sending the signal after electrically sensing the change in the position of the movable valve element.

36. The method of claim 33, wherein the dispensing module further comprises a movable valve element configured to selectively place the dispensing module in the recirculating condition and further comprising:
acoustically sensing a change in the position of the movable valve element, and
sending the signal after acoustically sensing the change in the position of the movable valve element.
